(19) United States
(12) Patent Application Publication
(10) Pub. No.: US 2012/0048810 A1
(43) Pub. Date: Mar. 1, 2012

(54) METHOD AND APPARATUS FOR CONTAMINANT RECOVERY

(76) Inventor: Todd Selman, Goleta, CA (US)

(21) Appl. No.: 12/868,738

(22) Filed: Aug. 26, 2010

(51) Int. Cl. E02B 15/10; B09C 1/00; E02B 15/00; C02F 1/40

(52) U.S. Cl. 210/738; 210/198.1; 210/170.1; 210/170.11; 210/170.09; 405/128.15; 405/60

(57) ABSTRACT

A contaminant recovery system for recovering contaminant in a contaminated area. The contaminant recovery system includes (i) a buffer configured to heat wax and thereby create molten wax, and (ii) a sprayer configured to spray the molten wax onto the contaminant within the contaminated area. The system further includes (i) a first line configured to deliver the molten wax from the buffer to the sprayer, and (ii) a second line configured to return the molten wax from the sprayer to the buffer in response to the sprayer being deactivated. The second line is separate from the first line.

### TECHNICAL FIELD

The present disclosure describes techniques and systems for contaminant recovery.

### BACKGROUND

Contaminant recovery is the process of recovering a contaminant that has spilled onto water or land. For example, contaminant recovery is typically required in cases of a marine oil spill, in which oil is released into a body of water—e.g, the ocean, coastal waters, lakes, reservoirs, or streams. Oil spills can occur due to releases of crude oil from tankers, offshore platforms, drilling rigs and wells, as well as spills of refined petroleum products (such as gasoline, diesel) and their by-products, and heavier fuels used by large ships such as bunker fuel, or the spill of any oily refuse or waste oil.

Contaminant recovery can also include removal of a contaminant from a container—e.g., a storage drum. For example, chemical storage companies typically store waste oil in storage drums, and such storage drums generally have a pre-determined lifetime associated with safe storage of waste oil. Once a storage drum is no longer fit to store waste oil, the waste oil is typically transferred into a newer storage drum and any residual waste oil remaining within the storage drum typically needs to be recovered for safe disposal of the storage drum.

### SUMMARY

In general, in one aspect, this specification describes a contaminant recovery system. The contaminant recovery system includes a buffer configured to heat wax and thereby create molten wax, and a sprayer configured to spray the molten wax onto the contaminant within the contaminated area. The contaminant recovery system further includes a first line a second line, each coupled between the buffer and the sprayer. The first line is configured to deliver the molten wax from the buffer to the sprayer, and the second line is configured to return the molten wax from the sprayer to the buffer in response to the sprayer being deactivated. The second line is separate from the first line.

Implementations can include one or more of the following features. The contaminated area can be located on a surface of water, and the sprayer can include a plurality of spray nozzles configured to spray the molten wax onto the surface of the water. A first spray nozzle of the plurality of spray nozzles can be directed to spray the molten wax towards the surface of the water from above the surface of the water. A second spray nozzle of the plurality of spray nozzles can be directed to spray the molten wax towards the surface of the water from below the surface of the water. The first spray nozzle can be positioned substantially opposite to the second spray nozzle.

The molten wax can solidify on the surface of the water and encapsulate the contaminant in the contaminated area, and the contaminant recovery system can further include a collector configured to collect the solidified wax containing the contaminant therein from the surface of the water. The contaminant recovery system can further include a collector and/or a separator. The separator can be configured to separate the contaminant from the solidified wax. The storage can be configured to store the contaminant removed from the solidified wax.

The contaminated area can be located on a surface of land, and the sprayer can include a spray nozzle configured to spray the molten wax onto the surface of the land. The contaminant recovery system can be hand-held. The sprayer can comprise a wand. The wand can have an adjustable length to permit an operator to direct the molten wax over a large portion of the contaminated area while the operator substantially remains at a same location. The contaminant recovery system can be implemented on a vessel. The vessel can comprise one or more of a yacht, a pontoon boat, a vehicle, or a trailer. The contaminated area can be located on an inner wall of a storage drum, and the sprayer can include a spray nozzle configured to spray the molten wax onto a surface of the inner wall of the storage drum.

In general, in another aspect, this specification describes a method for recovering contaminant in a contaminated area. The method includes using a buffer to heat wax and thereby create molten wax; and using a sprayer to spray the molten wax onto the contaminant within the contaminated area. The molten wax is delivered from the buffer to the sprayer over a first line coupled between the buffer and the sprayer. In response to the sprayer being deactivated, the molten wax is returned from the sprayer to the buffer over a second line coupled between the buffer and the sprayer, in which the second line is separate from the first line.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram of an example contaminant recovery system.

FIG. 2A illustrates one implementation of a sprayer for use with a contaminant recovery system.

FIG. 2B illustrates an example positioning of spray nozzles along the sprayer of FIG. 2A.

FIG. 2C illustrates one implementation of a system to support the sprayer shown in FIG. 2A.

FIG. 2D illustrates another implementation of a sprayer for use with a contaminant recovery system.

FIG. 3 is a block diagram of a hand-held contaminant recovery system including a sprayer.

FIG. 4A illustrates one implementation of the sprayer in FIG. 3.

FIG. 4B illustrates another implementation of the sprayer in FIG. 3.

FIG. 5 illustrates an example method for recovering a contaminant.

FIG. 6 is a block diagram of a vessel including a contaminant recovery system.

Like reference symbols in the various drawings indicate like elements.

### DETAILED DESCRIPTION

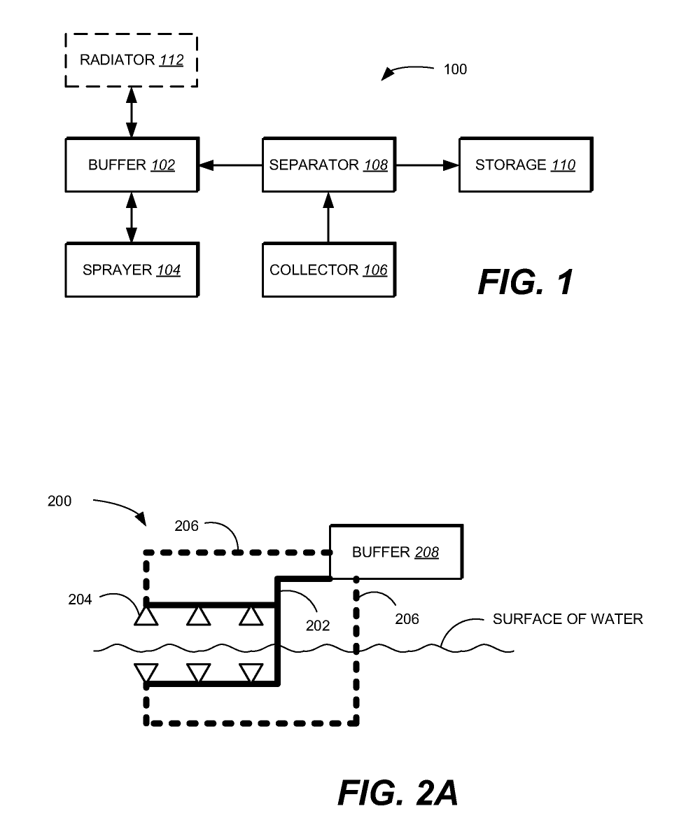

FIG. 1 illustrates one implementation of a contaminant recovery system 100. The contaminant recovery system 100 includes a buffer 102, a sprayer 104, a collector 106, a separator 108, and a storage 110. In one implementation, the contaminant recovery system 100 implements use of a wax to collect a contaminant. In such an implementation, the buffer 102 heats (and melts) the wax and pumps the molten wax to the sprayer 104. The sprayer 104, in turn, sprays the molten wax onto a contaminated area. As the sprayed wax cools and solidifies, the wax encapsulates the contaminant within the contaminated area. The collector 106 collects the solidified wax containing the contaminant, and provides the collected wax to the separator 108. A take-up system as described in U.S. Patent Application Publication No. 2009/0057217, which is incorporated herein by reference in its entirety, can be used to collect solidified wax. The separator 108 separates the contaminant from the collected wax, and stores the contaminant within the storage 110. In one implementation, the separator 108 also returns the wax (having the contaminant removed therefrom) back to the buffer 102 for subsequent reuse.

In one implementation, the sprayer 104 includes both (i) a main line (first line) that provides molten wax to one or more spray nozzles of the sprayer 104, and (ii) a return line (second line) that returns the molten wax to the buffer 102 for reuse—e.g., in the event that the spray nozzle(s) are closed (or shut off). In one implementation, the main line is separate from the return line. Unlike conventional sprayers that typically do not have a return line, any molten wax that remains in the main line during a time that the spray nozzles are closed can be returned back to the buffer 102. Accordingly, the molten wax does not have an opportunity to solidify within the main line and potentially clog the main line. In one implementation, the sprayer 104 includes one or more sensors (not shown) which can detect contaminate located on the surface of the water and automatically activate spray of wax from a given spray nozzle.

The contaminant recovery system 100 can further optionally include a radiator 112. The radiator 112 provides coolant to the buffer 102 as well as any other components of the contaminant recovery system 100 (e.g., the collector 106, the separator 108, and so on) to aid in cooling such components during use of the contaminant recovery system 100 on land or on water.

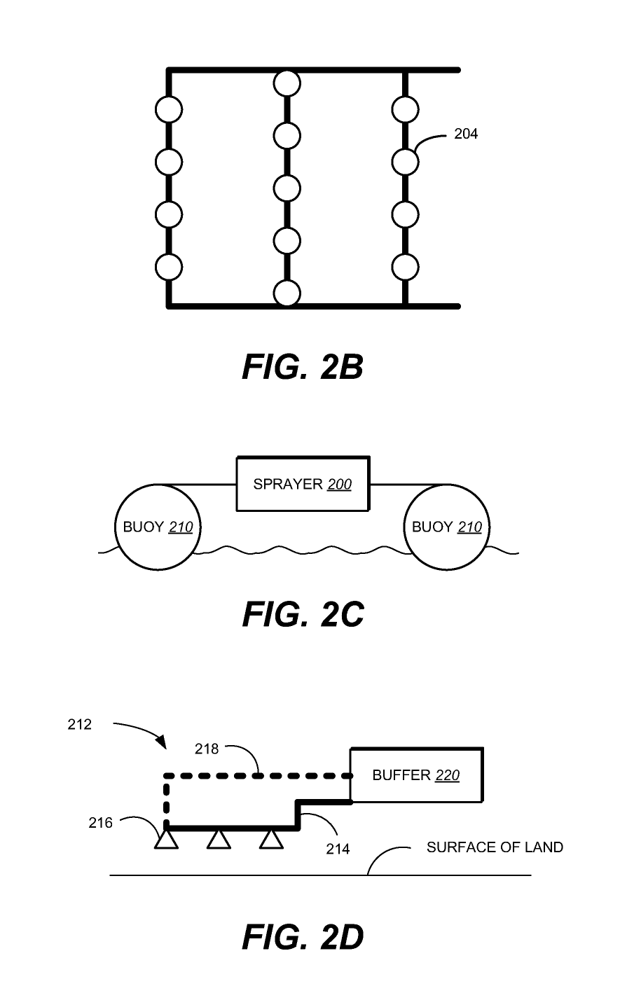

FIG. 2A illustrates one implementation of a sprayer 200 for use in recovering a contaminant located on the surface of water. The sprayer 200 includes (i) a main line 202 that receives molten wax from a buffer 208, and (ii) a plurality of spray nozzles 204 to spray the molten wax towards the surface of the water. The plurality of spray nozzles 204 can be arranged in rows, in which each row is staggered relative to an adjacent row as shown in FIG. 2B. In general, the plurality of spray nozzles can be positioned in a different manner to provide sufficient coverage of wax onto the surface of the water.

Referring back to FIG. 2A, each spray nozzle located above the surface of the water has a corresponding spray nozzle substantially located opposite to the spray nozzle underneath the surface of the water. The oppositely positioned spray nozzles (i.e., upper spray nozzle and lower spray nozzle) are positioned such that at least a portion of a spray area of the upper spray nozzle overlaps at least a portion of a spray area of the lower spray nozzle. Such positioning of spray nozzles aids in improving the encapsulation (or sandwiching) of a contaminant within the sprayed wax as the wax solidifies.

In order to prevent the main line 202 from being clogged with solidified wax in the event that the spray nozzles 204 are shut off, in one implementation, the sprayer 200 further includes return lines 206 to return the molten wax in the main line 202 back to the buffer 208. The main line 202 and/or the return lines 206 can be heated to maintain a molten state of the wax. In one implementation, only the portions of the main line 202 and the return line 206 located underneath the surface of the water are heated, while the portions of the main line 202 and the return line 206 located above the surface of the water are not heated.

The sprayer 200 can be either rigidly fixed or loosely coupled to the buffer 208. Referring to FIG. 2C, in one implementation, the sprayer 200 is coupled to one or more buoys 210 so that the spray nozzles of the sprayer 200 can substantially maintain a fixed distance relative to the surface of the water. In this implementation, the sprayer 200 can be coupled to the buffer 208 via a flexible, heated hot melt high pressure hose. The flexible, high pressure hose permits the sprayer 200 to float on the surface of the water separately from a vessel that contains the remaining components of the contaminant recovery system.

FIG. 2D illustrates one implementation of a sprayer 212 for use in recovering a contaminant located on the surface of land. The sprayer 212 includes (i) a main line 214 that receives molten wax from a buffer 220, and (ii) a plurality of spray nozzles 216 to spray the molten wax towards the surface of the land. The sprayer nozzles 216 can be positioned in one or more rows, in which each row is staggered relative to an adjacent row. In general, the spray nozzles 216 can be positioned in any manner to provide a sufficient spray area to cover a contaminated area. In one implementation, the sprayer 212 further includes a return line 218 to return the molten wax in the main line 214 back to the buffer 220. The main line 214 and/or the return lines 216 can be heated to maintain a molten state of the wax.

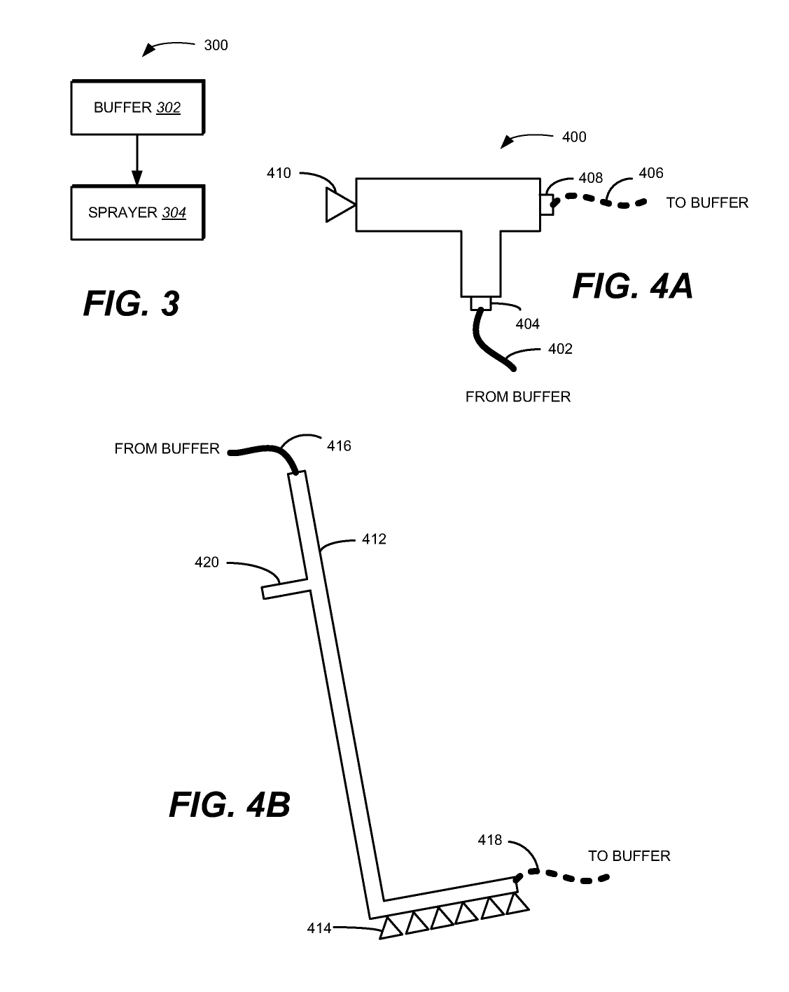

FIG. 3 illustrates one implementation of a hand-held contaminant recovery system 300. The contaminant recovery system 300 includes a buffer 302 and a sprayer 304. In one implementation, the contaminant recovery system 300 implements use of a wax to collect a contaminant. In such an implementation, the buffer 302 heats (and melts) the wax and pumps the molten wax to the sprayer 304. The sprayer 304, in turn, can be manually positioned or aimed to spray the molten wax onto a contaminated area. As the sprayed wax solidifies, the wax encapsulates contaminate within the wax, and the wax (containing the contaminant) can be recovered using any conventional techniques. In one implementation, the sprayer 304 is coupled to the buffer 302 via a flexible, heated high pressure hose.

FIG. 4A illustrates one implementation of a sprayer 400 that can be used with a hand-held contaminant recovery system (e.g., hand-held contaminant recovery system 300) to disperse molten wax onto a contaminated area. The sprayer 400 can be manually held by an operator, and includes one or more spray nozzles 410 that can be aimed by the operator towards a contaminated area. In one implementation, a flexible, heated hose 402 delivers molten wax to the sprayer 400. The flexible, heated hose 402 can be removably detachable from a fitting 404 located on the sprayer 400. In one implementation, the sprayer 400 further includes a fitting 408 to which a return line 406 can be attached. The return line 406 permits molten wax within the flexible hose 402 to return to a buffer (e.g., buffer 302) in the event that the sprayer 400 is not activated.

FIG. 4B illustrates one implementation of a sprayer 412 that can be used with a hand-held contaminant recovery system (e.g., hand-held contaminant recovery system 300) to disperse molten wax onto a contaminated area. In one implementation, the sprayer 412 is a heated wand available from Ocean Cleaning Consultant, Inc. of Oakland, Calif. The sprayer 412 can be manually held by an operator to disperse molten wax onto a contaminated area. In one implementation, the sprayer 412 includes a plurality of spray nozzles 414 to disperse molten wax over a relatively large area. In one implementation, the sprayer 412 further includes a handle 420 to permit an operator to more easily direct the spray of the molten wax towards a desired direction. The sprayer 412 can also have a length that is adjustable to permit an operator to direct spray at areas that may be unreachable with a hand-held sprayer such as sprayer 400 of FIG. 4A. In one implementation, the adjustable length of the sprayer 412 permits an operator to direct the molten wax over a large portion of a contaminated area while the operator substantially remains at a same location.

In one implementation, a flexible, heated hose 416 delivers molten wax to the sprayer 412. The flexible, heated hose 416 can be removably detachable from a fitting 416 located on the sprayer 412. In one implementation, the sprayer 412 further includes a fitting 418 to which a return line 418 can be attached. The return line 418 permits molten wax within the flexible hose 416 to return to a buffer (e.g., buffer 302) in the event that the sprayer 412 is not activated.

A hand-held contamination recovery system (e.g., hand-held contamination recovery system 300) is particularly useful in removing contaminant from large storage drums. Sprayers such as sprayer 400 and sprayer 412 permit molten wax to be sprayed along an inner surface of a storage drum. In some cases, storage drums are deeply embedded into the earth and require exhumation for proper disposal. In most cases, the inner walls of such storage drums typically experience corrosion and, therefore, may be in a weakened state—thus, making removal of storage drums from the earth a difficult process. By spraying the inner walls of a storage drum with molten wax, as the wax solidifies the wax not only encapsulates any contaminant that may be deposited on the inner walls, the solidifying wax also adds structural stiffness to the inner walls to permit the storage drum to be removed wholly from the earth without breaking up into pieces. Additionally, the solidified wax prevents small, corrosive chippings from falling away from the inner walls of the storage drum as the storage drum is transported for disposal.

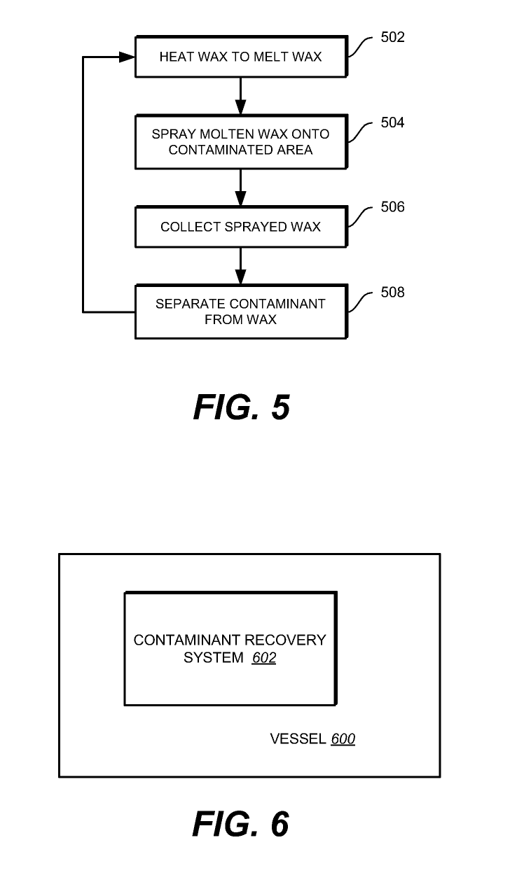

FIG. 5 illustrates a method 500 for recovering a contaminant in accordance with one implementation. Wax is heated (step 502). In one implementation, wax is heated using a buffer (e.g., buffer 102). In one implementation, the buffer comprises a hot melt unit to heat wax into a liquid form. The molten wax is sprayed onto a contaminated area (step 504). A sprayer (e.g., sprayer 104) can be used to spray the molten wax. In general, molten wax can be sprayed onto a contaminated area located on water or land. As the wax cools and solidifies, the wax encapsulates contaminant within the wax. The sprayed wax is collected (step 508). In one implementation, a collector (e.g., collector 106) can be implemented to collect the wax having the contaminant encapsulated therein. Alternatively, the wax can be collected by hand, suction hose, or by other recovery means. The contaminant is separated from the wax (step 508). In one implementation, a separator (e.g., separator 108) is implemented to separate the contaminant from the wax. Thereafter, the wax can be provided to the buffer for re-melt and reapplication onto the contaminated area.

FIG. 6 illustrates one implementation of a vessel 600 including a contaminant recovery system 602. The contaminant recovery system 602 can be a contaminant recovery system as described above (e.g., contaminant recovery system 100). In general, the vessel 600 can be a land-based vessel and/or a water-based vessel. The vessel 600 can be any vessel as described in U.S. Patent Application Publication No. 2009/0057217—e.g., a catamaran, a vehicle, a lightweight pontoon craft, and so on. Additionally, the vessel 600 can be a towable trailer that can be disconnected from a tow vehicle.

Various implementations for recovering contaminant using a contaminant recovery system have been described. Nevertheless, various modifications may be made to the implementations. For example, though the techniques described above refer to use of wax to recover a contaminant, the techniques are applicable to other types of elements or materials that can be sprayed to encapsulate a contaminant. Accordingly, many modifications may be made without departing from the scope of the following claims.

What is claimed is:

1. A contaminant recovery system for recovering contaminant in a contaminated area, the contaminant recovery system comprising:
a buffer configured to heat wax and thereby create molten wax; and
a sprayer configured to spray the molten wax onto the contaminant within the contaminated area;
a first line coupled between the buffer and the sprayer, the first line configured to deliver the molten wax from the buffer to the sprayer; and
a second line coupled between the buffer and the sprayer, the second line configured to return the molten wax from the sprayer to the buffer in response to the sprayer being deactivated,
wherein the second line is separate from the first line.

2. The contaminant recovery system of claim 1, wherein:
the contaminated area is located on a surface of water; and
the sprayer includes a plurality of spray nozzles configured to spray the molten wax onto the surface of the water,
wherein a first spray nozzle of the plurality of spray nozzles is directed to spray the molten wax towards the surface of the water from above the surface of the water,
wherein a second spray nozzle of the plurality of spray nozzles is directed to spray the molten wax towards the surface of the water from below the surface of the water, and
wherein the first spray nozzle is positioned substantially opposite to the second spray nozzle.

3. The contaminant recovery system of claim 2, wherein:
the molten wax solidifies on the surface of the water and encapsulates the contaminant in the contaminated area; and
the contaminant recovery system further includes a collector configured to collect the solidified wax containing the contaminant therein from the surface of the water.

4. The contaminant recovery system of claim 3, further comprising a separator configured to separate the contaminant from the solidified wax.

5. The contaminant recovery system of claim 4, further comprising a storage configured to store the contaminant removed from the solidified wax.

6. The contaminant recovery system of claim 1, wherein:
the contaminated area is located on a surface of land; and
the sprayer includes a spray nozzle configured to spray the molten wax onto the surface of the land.

7. The contaminant recovery system of claim 6, wherein the contaminant recovery system is hand-held.

8. The contaminant recovery system of claim 7, wherein the sprayer comprises a wand.

9. The contaminant recovery system of claim 8, wherein the wand has an adjustable length to permit an operator to direct the molten wax over a large portion of the contaminated area while the operator substantially remains at a same location.

10. The contaminant recovery system of claim 1, wherein the contaminant recovery system is implemented on a vessel.

11. The contaminant recovery system of claim 10, wherein the vessel comprises one or more of a yacht, a pontoon boat, a vehicle, or a trailer.

12. The contaminant recovery system of claim 1, wherein:
the contaminated area is located on an inner wall of a storage drum; and
the sprayer includes a spray nozzle configured to spray the molten wax onto a surface of the inner wall of the storage drum.

13. A method for recovering contaminant in a contaminated area, the method comprising:
using a buffer to heat wax and thereby create molten wax; and
using a sprayer to spray the molten wax onto the contaminant within the contaminated area,
wherein the molten wax is delivered from the buffer to the sprayer over a first line coupled between the buffer and the sprayer,
wherein, in response to the sprayer being deactivated, the molten wax is returned from the sprayer to the buffer over a second line coupled between the buffer and the sprayer, and
wherein the second line is separate from the first line.

14. The method of claim 13, wherein:
the contaminated area is located on a surface of water; and
the sprayer includes a plurality of spray nozzles configured to spray the molten wax onto the surface of the water,
wherein a first spray nozzle of the plurality of spray nozzles is directed to spray the molten wax towards the surface of the water from above the surface of the water,
wherein a second spray nozzle of the plurality of spray nozzles is directed to spray the molten wax towards the surface of the water from below the surface of the water, and
wherein the first spray nozzle is positioned substantially opposite to the second spray nozzle.

15. The method of claim 13, wherein:
the contaminated area is located on a surface of land; and
the sprayer includes a spray nozzle configured to spray the molten wax onto the surface of the land.
